(19) United States
(12) Patent Application Publication
(10) Pub. No.: US 2021/0304220 A1
(43) Pub. Date: Sep. 30, 2021

(54) COMPLEX SOURCING SYSTEM

(71) Applicant: Zycus Infotech Pvt. Ltd., Mumbai (IN)

(72) Inventors: Sarang Kulkarni, MUMBAI (IN); Nageswara Reddy Kondreddy, MUMBAI (IN); Chitra Kashyap, MUMBAI (IN); Kanishka Ghosh, MUMBAI (IN)

(73) Assignee: Zycus Infotech Pvt. Ltd., Mumbai (IN)

(21) Appl. No.: 17/206,448

(22) Filed: Mar. 19, 2021

(30) Foreign Application Priority Data
Mar. 26, 2020 (IN) 202021013130

(51) Int. Cl. G06Q 30/00; G06Q 50/18; G06Q 10/06; G06Q 30/08; G06Q 10/10; G06Q 10/08; G06F 16/22

(52) U.S. Cl. CPC G06Q 30/018; G06Q 50/188; G06Q 10/06313; G06Q 10/04; G06Q 10/10; G06Q 10/0875; G06F 16/2282; G06Q 30/08

(57) ABSTRACT

A complex sourcing system enabled to implement different permutations and combinations based on several different business constraints for optimal analysis, sourcing, multi-level negotiation, contracting, procurement and payment. The working of the complex sourcing system includes the steps of: (a) preparing for a bid; (b) creating a bid; (c) executing a bid; (d) selecting an optimal supplier; (e) storing the award and supplier details in the contract management module of the system; and (f) preparing a contract between the buyer and the supplier.

### CROSS-REFERENCE TO RELATED APPLICATION

The instant application claims priority to Indian Patent Application Serial No. 202021013130, filed Mar. 26, 2020, pending, the entire specification of which is expressly incorporated herein by reference.

### FIELD OF THE INVENTION

The present invention relates to a sourcing system and more particularly, to a complex sourcing system for implementing different permutations and combinations based on a plurality of business constraints for optimal analysis, sourcing, multi-level negotiation, contracting, procurement and payment.

### BACKGROUND OF THE INVENTION

Logistics plays an important role in integrating the supply chain of industries. Because the market is becoming more global, logistic companies play an important role in the industry by decreasing the cost and increasing the customer service quality.

The logistic companies have to spend a considerable amount of time and resources in preparing and executing a bid, before the final selection of the Supplier. These companies act as a connecting link or bridge between the buyer/companies and the supplier. The logistic companies first of all gets a list of supplier's selection criteria like cost related factors, discounts offered by the suppliers etc. after which an auction is executed wherein the suppliers provide information as requested from them and the supplier whose inputs are most suitable is selected. Thereafter, the supplier is allocated the lanes and a contract between the buyer and the supplier is executed.

Since these logistic companies have to make shipments across different regions, these logistic companies find it very difficult to conduct bidding of these lanes and to apply different permutations and combinations of different lanes across different regions to be allotted to different suppliers in case of a large event wherein there are thousands of lanes in different regions for which hundreds of suppliers are bidding.

U.S. Pat. No. 6,915,268 discloses a logistics system and method operated by a third party intermediary for management of shipment of goods supplied from plurality of different suppliers by plurality of different carriers. The logistics system passes the customer orders of a plurality of shippers directly to a plurality of carriers and then provides an information flow back from the carriers to the shippers so that there is management of shipments for all the parties involved.

However, the prior art fails to provide a solution for shipments in large events wherein it is not feasible to directly pass the orders to the suppliers and automatic evaluation is necessary. Thus, the present invention overcomes the limitations of the prior art by providing a complex sourcing system which implements different permutations and combinations for optimal analysis and sourcing for large events.

### OBJECTS OF THE INVENTION

The primary object of the present invention is to provide for a novel system and method which implements different permutations and combinations based on plurality of business constraints for optimal analysis, sourcing, multi-level negotiation, contracting, procurement and payment.

Yet another object of the present invention is to provide for a complex sourcing system which selects the optimal supplier by providing in-built standard bid optimization scenarios.

Yet another object of the present invention is to provide for a complex sourcing system which generates automated supplier ranking and provides a highly intuitive supplier side portal access.

Yet another object of the present invention is to provide for a complex sourcing system which minimises the cost by providing flexible price building, multi-round negotiation feature and, data analysis across multiple price and non-price parameters.

Yet another object of the present invention is to provide for a complex sourcing system which efficiently performs constraint based analysis and improved computation using decision making models.

Yet another object of the present invention is to provide for a complex sourcing system which provides flexible event scheduling and prepares the contract.

Further the object of the present invention is to provide for a complex sourcing system which saves physical efforts, time and increases productivity on the whole.

### SUMMARY OF THE INVENTION

The present invention discloses a system for complex sourcing for large events. This advanced system is such that it is enabled with advanced features to analyse large events, which are otherwise difficult to be done manually and are not merely cherry picking of constraints and selecting the suppliers.

The complex sourcing system in the present invention applies different permutations and combinations based on a plurality of business constraints for optimal analysis, sourcing, multi-level negotiation, contracting, procurement and payment.

The working of the complex sourcing system includes the steps of: a) preparing for a bid, b) creating a bid, c) executing a bid d) selecting an optimal supplier, e) storing the award and supplier details in the contract management module of the system and f) preparing a contract between the buyer and the supplier.

In the present invention, to select the optimal supplier, the system runs business constraints and compliance related constraints model and in addition to that, also takes into consideration if any discounts are offered by any supplier. The two broad level business constraints used in the present invention are: a) minimization of cost related business constraints and b) environmental compliance constraints.

### DETAILED DESCRIPTION OF THE INVENTION

Before the present invention is described, it is to be understood that this invention is not limited to particular methodologies described, as these may vary as per the person skilled in the art. It is also to be understood that the terminology used in the description is for the purpose of describing the particular embodiments only, and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

The complex sourcing system of the present invention is enabled to conduct bidding of thousands of lanes for making shipment across thousands of regions in logistics companies. For example, in an auction the logistic company may have 20,000 lanes across different regions having different shipment requirement. When these lanes for shipment are put on auction for suppliers to bid lanes for shipment then logistic company do not want to award all lanes across different regions to one supplier for making shipments. They want to have different business constraints for allocating different lanes to different suppliers based on permutations and combinations of different business constraint, this is not feasible to do manually on excel handling 20,000 lanes, 50 suppliers and different permutations and combination of business constraints for allocation of lanes but, the complex sourcing system can select an optimal supplier for such large events.

In the present invention, the complex sourcing system collects data from bidders in the form of structured tables. The information which is collected from the suppliers is interpreted by applying different permutations and combinations on it for the selection of an optimal supplier.

The complex sourcing system is enabled with advanced features to analyse large events, which are difficult to be done manually and are not merely cherry picking of constraints and selecting the suppliers. These advanced features of the complex sourcing system include:

Advance analytics capabilities which allow the system to apply complex business criteria simultaneously. The system contains business constraints model which applies various business constraints simultaneously based on various criteria of permutations and combinations which is imbibed in the model.

Easy integrations in the system which means addition of different modules to the e-Sourcing module. The system can be easily integrated with other systems and modules like contract management and sourcing applications via interfaces, API.

Cutting edge technology business constraints makes it feasible for the system to find an optimal supplier mix which is done which the help of the business constraints model which runs various business constraints permutations and combinations processing means imbibed in the model to find optimal supplier mix in less than a couple of hours. The system is efficient to find the optimal supplier even in the most difficult scenario for example, at the time of handling 10,000 lanes, 100 suppliers or more and trying to allot lanes by various permutations and combinations of business constraints.

In the preferred embodiment of the present invention, there are three main key attributes of the complex sourcing system which are mentioned below:

Data: It describes the large amount of data and the list of participating suppliers;

Interpretation: This attribute emphasises that with large amount of data comes the need for simpler interpretation;

Business logic: This attribute illustrates that when variety of business criteria/needs/ideas are put together makes problem a complex one.

In the present invention, the series of steps which describe the working of the Complex Sourcing System are as follows:

Preparation of the Bid: To prepare for the bid, the system collects data from the bidders in structured tables in databases. To collect the data from the suppliers, a RFI which is a request for information is created within the system. For the purpose of auction/tender the RFI is floated to suppliers. This RFI is a structured data file consisting of various rows and columns wherein there are certain questions related to the “lanes” for bidding purpose. The suppliers provide inputs to those questions as their bid responses. The RFI includes creating various columns to invite inputs related to number of lanes, designate volumes & freight types associated with those lanes. The system further allows the user to select lane descriptions from the repository of previous lanes put on action. To create large events, the RFI includes information related to pricing and non-pricing conditions, items lanes 10,000-logistics-support.

Creation of the Bid: To create a bid, the system sets the project structure and format, sets the lane and freight type, sets alternate lanes by combining other lanes, sets requirement for dock fees, management fees, handling Fees etc. The system collects detailed information of the shipments including the number of lanes, the mode of shipments for the lanes that is by air, road or ship, description of lanes which includes lane numbers, regions etc., the quantity of goods to be shipped and other details of shipments.

Execution of the bid: To execute the bid, the suppliers are required to provide responses to the RFI sent to them during preparation of bid.

Selection of optimal supplier: Upon collection of bids responses, the system runs business constraints and compliance related constraints model and in addition to that, also takes into consideration if any discounts are offered by any supplier. After processing all the information and running different constraint based tests on the information, the system provides best results of selected suppliers and the awards provided to them as number of lanes and shipments.

The complex sourcing system can use number of constraints to select the optimal supplier for the allocation of lanes. The two broad level business constraints used in the present invention are given below:

Minimization of cost related business constraints: In this category of constraints, the system applies all the business constraints that can be incorporated as a part of the complex sourcing system. The customers can configure all or any of the constraints which are mentioned below while creating award scenarios. The business constraint model runs these business constraint criteria in various permutations and combinations. Some of these business constraint criteria also contain sub-criteria which help in defining the limits of the criteria. All the business constraints that can be incorporated as a part of the complex sourcing system are as follows:

Supplier award value criteria: It describes the total business amount in the event currency allocated to the supplier. It has two sub criteria:

Minimum award value (absolute value or percentage) per supplier; and

Maximum award value (absolute value or percentage).

Supplier award volume criteria: It describes the total number of lanes allocated to each supplier. It has two sub criteria:

Minimum number of supplier per lane; and

Maximum number of supplier per lane.

Tiered award allocation-supplier count criteria: This criterion is meant to define the number of suppliers amongst whom the total business of the lane should be divided. It contains a primary use case scenario which can be used in case the buyer wants to allocate business to a primary and secondary carrier per lanes. It has two sub criteria:

Minimum number of supplier per lane; and

Maximum number of supplier per lane.

Tiered award allocation-supplier award quantity criteria: This criterion defines the allocation of a single item (lane) to a primary or secondary supplier in a specified proportion. It has two sub criteria:

Quantity award percentage to be allocated to the primary supplier (for ex. 80%); and

Quantity award percentage to be allocated to the secondary supplier (for ex. 20%).

Supplier capacity criteria: This criterion will allocate the business volume of a lane to a supplier based on the supplier proposed quantity. The volume awarded to a supplier will not exceed capacity of the supplier. It has one sub criteria:

Supplier proposed volume for each lane (this is input as a part of the supplier response).

Supplier count criteria: This criterion will allocate the total business amongst a specific number of suppliers. It has three sub criteria:

Minimum supplier count for the award scenario;

Maximum supplier count for the award scenario;

Exact supplier count for the award scenario.

Bundle bidding criteria: The criteria give an option to the suppliers to provide additional discount on a group of items if the items are allocated to them in the award scenario. The criteria will take the bundled bids submitted by the supplier into account while applying the optimization processing means.

Discount bidding criteria: The criteria gives an option to the suppliers to provide additional discount on an item if a specific percentage of the award volume (usually equal or greater than the designated percentage) for the item is allocated to them in the award scenario. The criteria will take the discount bids submitted by the supplier into account while applying the optimization processing means.

Item group-based criteria: these criteria can be applied when a selection of items is grouped together based on some single or multiple parameters. The user defines a supplier group from which the awardees for the items must be picked. This will be considered by the optimization processing means while making the award. For example, All the lanes originating from Madrid should be awarded from the supplier group A, B, C.

Another category of important business constraint includes the environmental compliance constraints especially carbon emission threshold check criteria. In this set of constraints, the buyer will set carbon emission related business constraint for each set of lanes and for each region. The suppliers will provide inputs to these aspects in the RFI and accordingly the selection of the suppliers will be based on the fulfilment of these constraints along with other business cost saving constraints.

In another embodiment of the present invention, in addition to the above-mentioned broad categories of business constraints, the complex sourcing system also considers the discount based criteria which describe the discounts offered by supplier for selecting the right permutations and combinations of suppliers for the lanes. The suppliers may offer bundle discounts for example, supplier 1 may offer 10% discounts if 500 lanes of x-region are allotted to him by the buyer. The system takes into consideration these discount offers before the allocation of the award.

Storing the award and supplier details in the contract management module of the system: After allocating the award to the suppliers, the award details and supplier details are stored in the contract management module of the system as inputs to the metadata fields. These metadata fields are captured and stored in a structured form present within contract management module.

Preparing the contract between the buyer and the supplier: The inputs stored in the metadata fields in the contract management module of the system are retrieved and used by the system to fill in the details of the contract, as header of contract and commercial detail.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term“mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY™ and TREO™ devices), multimedia Internet enabled cellular telephones (e.g., the BLACKBERRY STORM™, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A complex sourcing system for implementing different permutations and combinations based on a plurality of business constraints for optimal analysis, sourcing, multi-level negotiation, contracting, procurement and payment. comprising:
a subsystem for preparing for a bid;
a subsystem for creating a bid;
a subsystem for executing a bid;
a subsystem for selecting a supplier;
a subsystem for storing the award and supplier details in the contract management module of the system; and
a subsystem for preparing a contract between a buyer and the supplier.

2. The system as claimed in claim 1, wherein the system prepares for the bid by collecting information from the supplier in structured tables in databases by sending a request for information (RFI) to the supplier.

3. The system as claimed in claim 1, wherein the system executes the bid by retrieving an RFI response of the supplier.

4. The system as claimed in claim 1, wherein the system is enabled to select the supplier by processing the information and running different business constraints and compliance related constraints tests on the information.

5. The system as claimed in claim 4, wherein the business constraints include two broad level constraints of minimization of cost related business constraints and environmental compliances for the selection of a supplier.

6. The system as claimed in claim 5, wherein the cost related business constraints runs the following business constraint criteria in various permutations and combinations:
supplier award value criteria;
supplier award volume criteria;
tiered award allocation-supplier count criteria;
tiered award allocation-supplier award quantity criteria;
supplier capacity criteria;
supplier count criteria;
bundle bidding criteria;
discount bidding criteria; and
item group-based criteria.

7. The system as claimed in claim 5, wherein the environment compliance constraints runs the carbon emission check criteria in various permutations and combinations on the inputs received from the supplier.

8. The system as claimed in claim 1, wherein the system stores the award and supplier details in the contract management module for preparing the contract between the buyer and the supplier.

9. The system as claimed in claim 8, wherein the contract management module contains the award and supplier details in metadata fields which are retrieved and used by the system to fill in details of the contract, as header of contract and commercial details.
